(19) United States
(12) Patent Application Publication
(10) Pub. No.: US 2018/0363334 A1
(43) Pub. Date: Dec. 20, 2018

(54) ATTACHMENT MEMBER AND LOCK HAVING THE SAME

(71) Applicant: Sinox Co., Ltd., New Taipei City (TW)

(72) Inventor: Chia-Ming WU, New Taipei City (TW)

(21) Appl. No.: 16/007,826

(22) Filed: Jun. 13, 2018

(30) Foreign Application Priority Data
Jun. 16, 2017 (TW) 106208742

(51) Int. Cl. E05B 73/00

(52) U.S. Cl. CPC E05B 73/0082; E05B 73/0005

(57) ABSTRACT

A lock contains: an attachment member and a fixing device. The attachment member includes a base, a first movable connection part and a second movable connection part which are rotatably connected on the base can expandable outward and retractable inward. The first movable connection part has a first extension, a first post opposite to the first extension, and a first tab. The second movable connection part has a second extension, a second post opposite to the second extension, and a second tab. The fixing device includes a case and a locking mechanism. The case is configured to fit with the base and has a retaining groove. The locking mechanism is arranged in the case and includes a movable rod configured to separate the first movable connection part from the second movable connection part.

### FIELD OF THE INVENTION

The present invention relates to a lock having an attachment member which is connected with a locking orifice of a portable device.

### BACKGROUND OF THE INVENTION

A portable device (such as a laptop) is in a small size and is expensive, and it is easy to be stolen because of high price and sell with ease.

To overcome such a problem, the portable device has a locking orifice configured to connect with the lock. Normal locking orifice is rectangular and its length and width are 3 mm×7 mm, however there are also 2.5 mm×6 mm, or 3.2 mm×4.5 mm locking orifices to match with various sizes of locks, thus having using limitation.

The present invention has arisen to mitigate and/or obviate the afore-described disadvantages.

### SUMMARY OF THE INVENTION

The primary aspect of the present invention is to provide a lock having an attachment member which is connected with a locking orifice of a portable device.

To obtain above-mentioned aspect, a lock provided by the present invention contains an attachment member and a fixing device.

The attachment member is configured to connect with a locking orifice of a portable device, and the attachment member includes a base, a first movable connection part and a second movable connection part which are rotatably connected on the base can expandable outward and retractable inward, wherein the first movable connection part has a first extension coupled with the locking orifice, a first post opposite to the first extension, and a first tab formed on an outer wall of the first post, wherein the second movable connection part has a second extension coupled with the locking orifice, a second post opposite to the second extension, and a second tab formed on an outer wall of the second post.

The fixing device includes a case and a locking mechanism.

The case is configured to fit with the base and has a retaining groove formed in the case.

The locking mechanism is arranged in the case and includes a movable rod configured to separate the first movable connection part from the second movable connection part so that the first protrusion of the first post and the second protrusion of the second post retain in a first position of the retaining groove, the first movable connection part and the second movable connection part expand outward or retract inward, and the first protrusion of the first post and the second protrusion of the second post remove from a second position of the retaining groove.

Preferably, the base is a circular column.

Preferably, the first post of the first movable connection part has a first recess formed on an inner wall thereof, and the second post of the second movable connection part has a second recess formed on an inner wall thereof.

Preferably, the first post further has a first tilted guide face arranged on an edge thereof, and the second post further has a second tilted guide face arranged on an edge thereof.

Preferably, the locking mechanism is a key locking mechanism.

Preferably, the locking mechanism is a combination locking mechanism.

Preferably, the case is in connection with a flexible chain.

### BRIEF DESCRIPTION OF THE DRAWINGS

FIG. 1 is a perspective view showing the exploded components of a lock according to a first embodiment of the present invention.

FIG. 2 is another perspective view showing the exploded components of the lock according to the first embodiment of the present invention.

FIG. 3 is a cross-sectional perspective view showing the exploded components of the lock according to the first embodiment of the present invention.

FIG. 4 is a cross-sectional perspective view showing the assembly of the lock according to the first embodiment of the present invention.

FIG. 5 is a perspective view showing the assembly of the lock according to the first embodiment of the present invention.

FIGS. 6A-6E are a cross sectional view showing the operation of the lock according to the first embodiment of the present invention.

FIG. 7A is a side plan view showing the assembly of an attachment member according to a second embodiment of the present invention.

FIG. 7B is a side plan view showing the operation of the attachment member according to the second embodiment of the present invention.

FIG. 8A is a side plan view showing the assembly of an attachment member according to a third embodiment of the present invention.

FIG. 8B is a side plan view showing the operation of the attachment member according to the third embodiment of the present invention.

FIG. 9 is a perspective view showing the application of a lock according to a fourth embodiment of the present invention.

FIG. 10 is a perspective view showing the exploded components of the lock according to the fourth embodiment of the present invention.

FIG. 11A is a side plan view showing the operation of the lock according to the fourth embodiment of the present invention.

FIG. 11B is another side plan view showing the operation of the lock according to the fourth embodiment of the present invention.

### DETAILED DESCRIPTION OF THE PREFERRED EMBODIMENTS

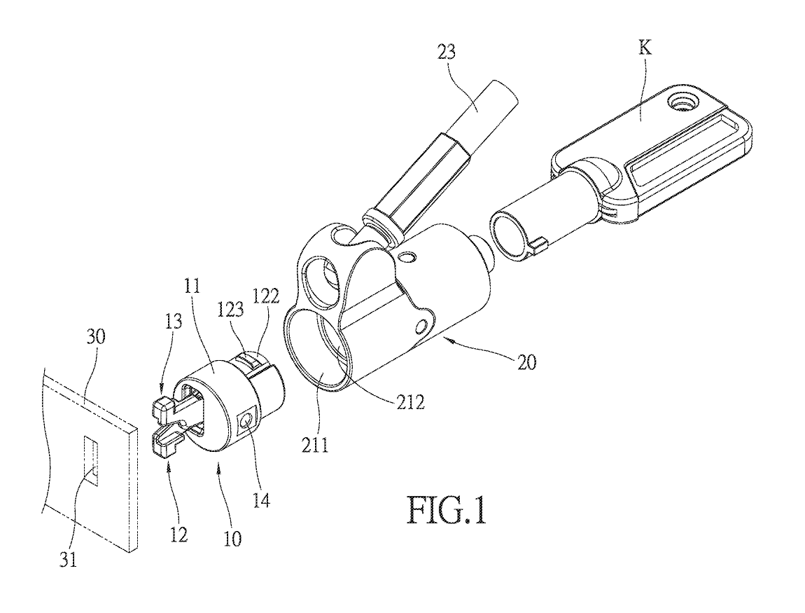

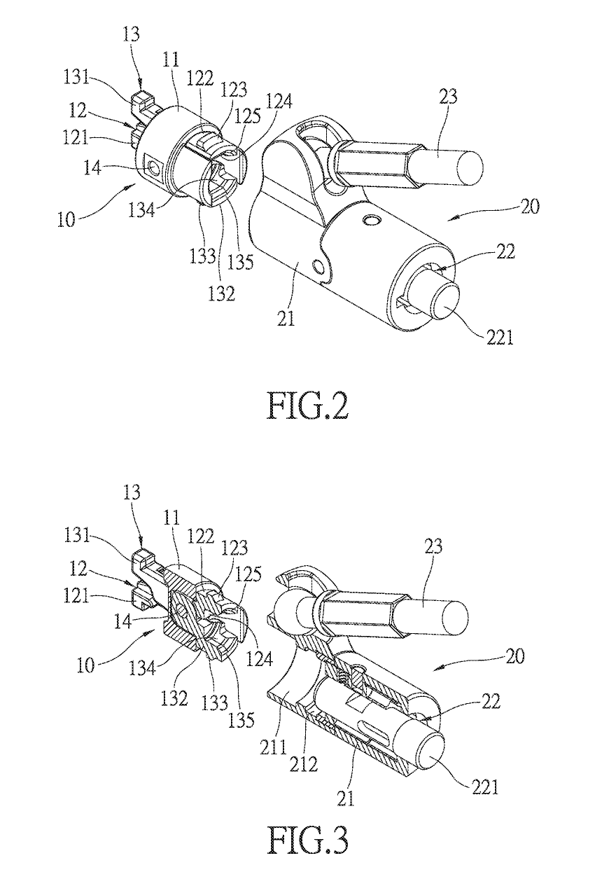

With reference to FIGS. 1-3, a lock according to a first embodiment of the present invention comprises an attachment member 10 configured to connect with a locking orifice 31 or a locking cavity of a portable device 30, and a fixing device 20 connecting with the attachment member 10.

The attachment member 10 includes a base 11, a first movable connection part 12 and a second movable connection part 13 which are rotatably connected on the base 11 by using a coupling haft 14 allow the first movable connection part 12 and the second movable connection part 13 to expandable outward and retractable inward, wherein the first movable connection part 12 has a first extension 121 coupled with the locking orifice, a first post 122 opposite to the first extension 121, and a first tab 123 formed on an outer wall of the first post 122, wherein the second movable connection part 13 has a second extension 131 coupled with the locking orifice, a second post 132 opposite to the second extension 131, and a second tab 133 formed on an outer wall of the second post 132.

The fixing device includes a case 21 and a locking mechanism 22 arranged in the case 21. The case 21 has a circular opening 211 defined on an end thereof so as to fit with the base 11, and the case 21 has a retaining groove 212 formed therein. The case 21 is in connection with a flexible chain 23 or a cable. The locking mechanism 22 includes a movable rod 221 configured to separate the first movable connection part 12 from the second movable connection part 13 so that the first protrusion 123 of the first post 122 and the second protrusion 133 of the second post 132 retain in a first position of the retaining groove 212, the first movable connection part 12 and the second movable connection part 13 expand outward or retract inward, and the first protrusion 123 of the first post 122 and the second protrusion 133 of the second post 132 remove from a second position of the retaining groove 212. The first post 122 of the first movable connection part 12 has a first recess 124 formed on an inner wall thereof, and the second post 132 of the second movable connection part 13 has a second recess 134 formed on an inner wall thereof. The first post 122 further has a first tilted guide face 125 arranged on an edge thereof, and the second post 132 further has a second tilted guide face 135 arranged on an edge thereof.

The base 11 is a circular column so as to match with the circular opening 211 of the case 2 and to movably fit the fixing device 20 on the base 11.

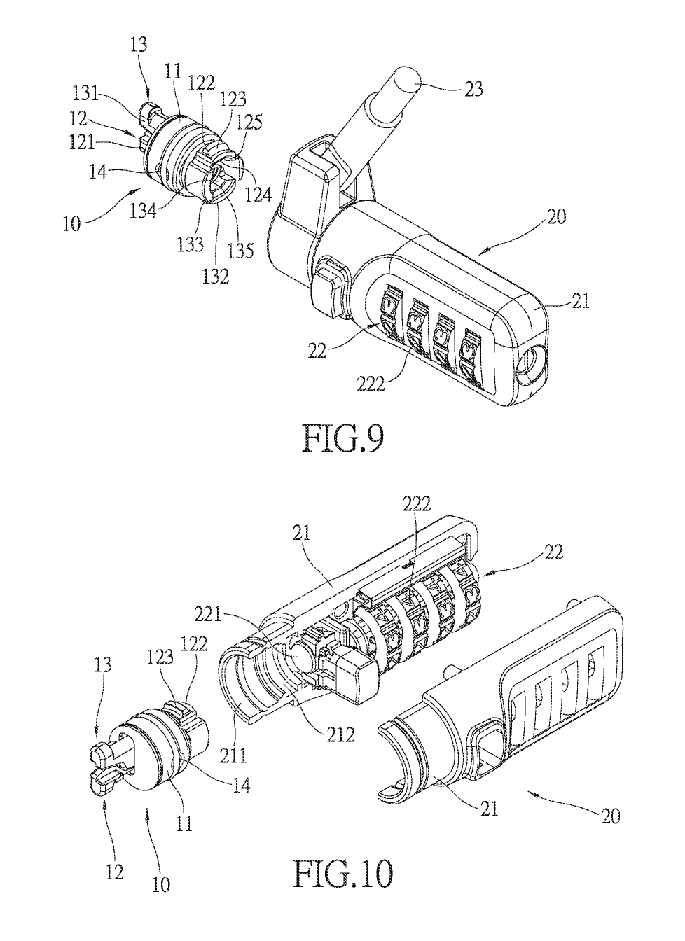

The locking mechanism 22 is a key locking mechanism which is locked or unlocked by using a key K. In another embodiment, the locking mechanism 22 is a combination locking mechanism, as shown in FIGS. 9 and 10. In another embodiment, the locking mechanism 22 is a combination of the key locking mechanism and the combination locking mechanism.

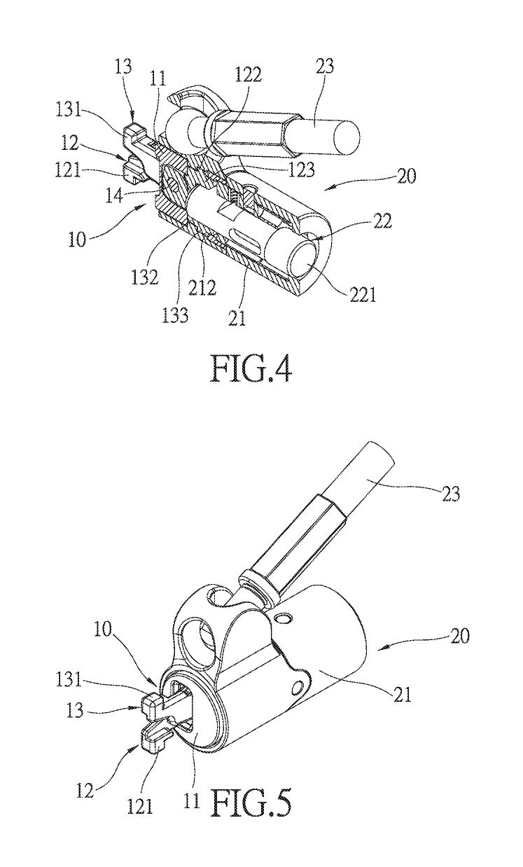

Referring to FIGS. 4 and 5, the lock of the present invention comprises the attachment member 10 and the fixing device 20 connecting with the attachment member 10 so that the first movable connection part 12 and the second movable connection part 13 are locked.

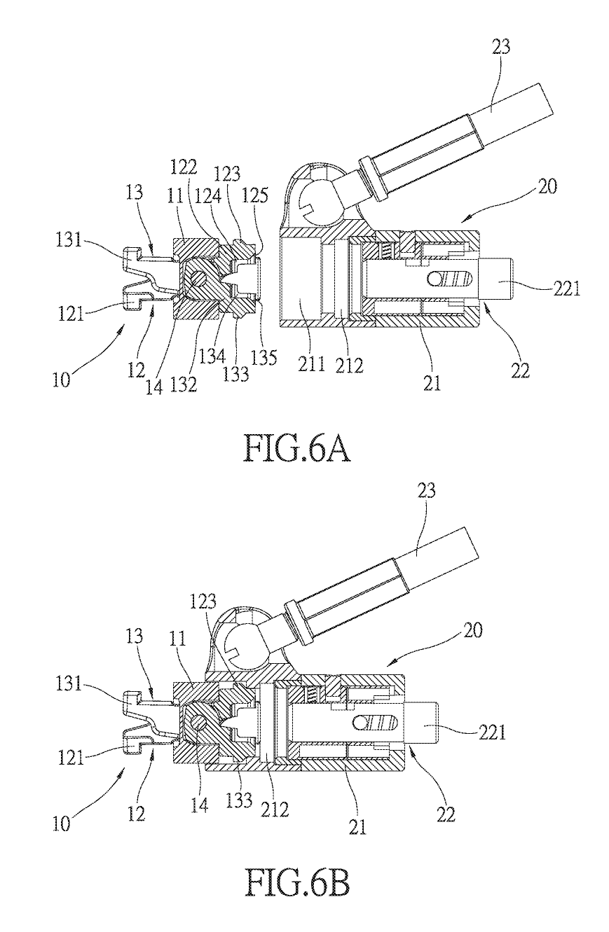

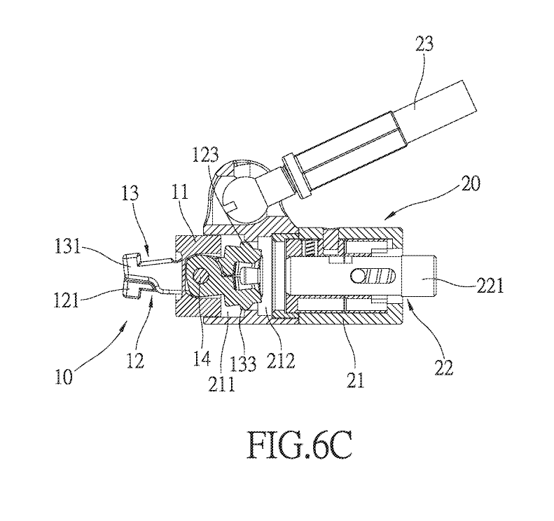

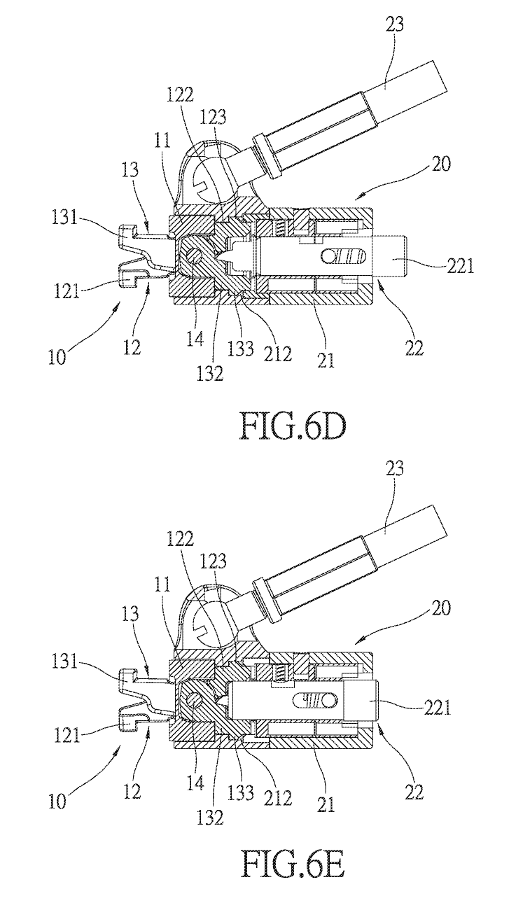

FIGS. 6A-6E are a cross-sectional view showing the operation of the lock according to the preferred embodiment of the present invention. As shown in FIG. 6A, the first extension 121 of the first movable connection part 12 and the second extension 131 of the second movable connection part 13 are coupled with the locking orifice of the portable device. As illustrated in FIGS. 6B-6C, the case 21 of the fixing device 20 is fitted with an end of the attachment member 10 so that the first post 122 of the first movable connection part 12 and the second post 132 of the second movable connection part 13 move into the circular opening 211 until the first protrusion 123 of the first post 122 and the second protrusion 133 of the second post 132 retain in the retaining groove 212. As shown in FIG. 6D, after the movable rod 221 of the fixing mechanism 22 moves to the second position of the retaining groove 212 from the first position of the retaining groove 21, the movable rod 221 is fixed in the first recess 124 and the second recess 134 via the first tilted guide face 125 and the second tilted guide face 135 so that the first movable connection part 12 and the second movable connection part 13 of the attachment member 10 are locked.

In contrast, the movable rod 221 is moved back to the first position so that the first movable connection part 12 and the second movable connection part 13 retract inward, and the first protrusion 123 of the first post 122 and the second protrusion 133 of the second post 132 remove from the retaining groove 212, thus detaching the fixing device 20 from the attachment member 10.

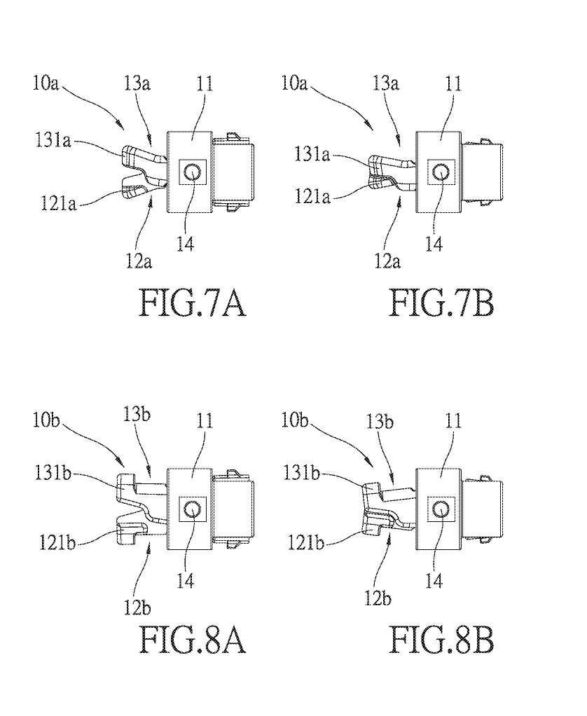

FIGS. 7A and 7B are a side plan view showing the assembly of an attachment member according to a second embodiment of the present invention. FIGS. 8A and 7B are a side plan view showing the assembly of an attachment member according to a third embodiment of the present invention. For example, the attachment member 10 matches with the portable devices having locking orifices of various sizes and shapes respectively. Preferably, the attachment member 10 is detachable from the fixing device 20, so attachment members 10a, 10b match with first and second extensions 121a, 131a, 121b, 131b of first and second movable connection parts 12a, 12b, 13a, 13b of various sizes and shapes.

Referring to FIGS. 9 and 10, in a fourth embodiment, a lock having an attachment member is a combination locking mechanism, wherein the lock comprises an attachment member 10 configured to connect with a locking orifice or a locking cavity of a portable device, and a fixing device 20 connecting with the attachment member 10.

The attachment member 10 includes a base 11, a first movable connection part 12 and a second movable connection part 13 which are rotatably connected in the base 11 by using a coupling shaft 14 so as to be expandable and retractable with each other, wherein the first movable connection part 12 has a first extension 121 coupled with the locking orifice, a first post 122 opposite to the first extension 121, and a first tab 123 formed on an outer wall of the first post 122, wherein the second movable connection part 13 has a second extension 131 coupled with the locking orifice, a second post 132 opposite to the second extension 131, and a second tab 133 formed on an outer wall of the second post 132.

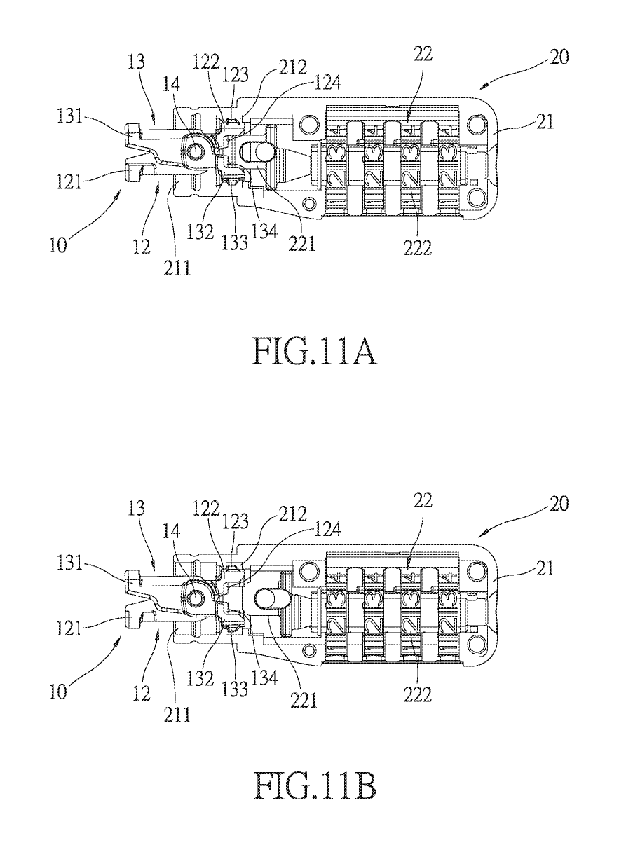

The locking mechanism 22 of the fixing device 20 is a combination locking mechanism so as to lock or unlock the attachment member by way of a rotating disc 222. The locking mechanism 22 includes a movable rod 221 configured to separate the first movable connection part 12 from the second movable connection part 13 when the attachment member 10 is fitted with the fixing device 20, and the first protrusion 123 of the first post 122 and the second protrusion 133 of the second post 132 retain in a first position of the retaining groove 212 (as shown in FIG. 11A). On the contrary, the movable rod 221 is moved so that the first movable connection part 12 and the second movable connection part 13 retract inward, and the first protrusion 123 of the first post 122 and the second protrusion 133 of the second post 132 remove from the second position of the retaining groove 212 (as illustrated in FIG. 11B).

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A lock comprising:
an attachment member configured to connect with a locking orifice of a portable device, and the attachment member including a base, a first movable connection part and a second movable connection part which are rotatably connected on the base can expandable outward and retractable inward, wherein the first movable connection part has a first extension coupled with the locking orifice, a first post opposite to the first extension, and a first tab formed on an outer wall of the first post, wherein the second movable connection part has a second extension coupled with the locking orifice, a second post opposite to the second extension, and a second tab formed on an outer wall of the second post;
a fixing device including:
a case configured to fit with the base and having a retaining groove formed in the case; and
a locking mechanism arranged in the case and including a movable rod configured to separate the first movable connection part from the second movable connection part so that the first protrusion of the first post and the second protrusion of the second post retain in a first position of the retaining groove, the first movable connection part and the second movable connection part expand outward or retract inward, and the first protrusion of the first post and the second protrusion of the second post remove from a second position of the retaining groove.

2. The lock as claimed in claim 1, wherein the base is a circular column.

3. The lock as claimed in claim 1, wherein the first post of the first movable connection part has a first recess formed on an inner wall thereof, and the second post of the second movable connection part has a second recess formed on an inner wall thereof.

4. The lock as claimed in claim 3, wherein the first post further has a first tilted guide face arranged on an edge thereof, and the second post further has a second tilted guide face arranged on an edge thereof.

5. The lock as claimed in claim 1, wherein the locking mechanism is a key locking mechanism.

6. The lock as claimed in claim 1, wherein the locking mechanism is a combination locking mechanism.

7. The lock as claimed in claim 1, wherein the case is in connection with a flexible chain.

8. An attachment member being configured to connect with a locking orifice of a portable device, and the attachment member comprising:
a base;
a first movable connection part and a second movable connection part which are rotatably connected on the base and are expandable outward and retractable inward, wherein the first movable connection part has a first extension coupled with the locking orifice, a first post opposite to the first extension, and a first tab formed on an outer wall of the first post, wherein the second movable connection part has a second extension coupled with the locking orifice, a second post opposite to the second extension, and a second tab formed on an outer wall of the second post.

9. The lock as claimed in claim 1, wherein the base is a circular column.

10. The lock as claimed in claim 1, wherein the first post further has a first tilted guide face arranged on an edge thereof, and the second post further has a second tilted guide face arranged on an edge thereof.
